(19) United States
(12) Patent Application Publication
(10) Pub. No.: US 2016/0054806 A1
(43) Pub. Date: Feb. 25, 2016

(54) DATA PROCESSING APPARATUS, DATA PROCESSING SYSTEM, CONTROL METHOD FOR DATA PROCESSING APPARATUS, AND STORAGE MEDIUM

(71) Applicant: CANON KABUSHIKI KAISHA, Tokyo (JP)

(72) Inventor: Ryo Kosaka, Tokyo (JP)

(21) Appl. No.: 14/823,543

(22) Filed: Aug. 11, 2015

(30) Foreign Application Priority Data
Aug. 20, 2014 (JP) 2014-167828

(51) Int. Cl. G06F 3/01

(52) U.S. Cl. CPC G06F 3/017

(57) ABSTRACT

A data processing apparatus acquires a range image and identifies an operator who has performed a gesture operation on the operation screen based on the acquired range image, performs control so as to validate, when the identified operator is the first operator, a gesture operation on a first operation item in the operation screen, and to invalidate, when the identified operator is the second operator, a gesture operation on the first operation item, and so as to invalidate, when the identified operator is the first operator, a gesture operation on a second operation item in the operation screen, and to validate, when the identified operator is the second operator, a gesture operation on the second operation item.

### BACKGROUND OF THE INVENTION

1. Field of the Invention

The present invention relates to a data processing apparatus in which a plurality of operators can simultaneously operate a single operation screen including a plurality of operation items, and a data processing system, a control method for the data processing apparatus, and a storage medium.

2. Description of the Related Art

In recent years, camera scanners have been known as an apparatus that reads image data of a document. The camera scanner captures an image of a document placed on a platen, and then processes and stores image data of the document captured by the camera (see Japanese Patent Application Laid-Open No. 2006-115334).

Furthermore, an image processing system has been known in which a projector projects a captured image data obtained by the camera in such a camera scanner and an operation button onto the platen. In the image processing system, an operation such as printing of the captured image data can be performed by detecting an operation performed by a user on a projected screen.

However, the image processing system described above is not expected to be used in cases where a plurality of operators simultaneously operates the operation screen. Such a case includes an insurance contract procedure where a camera captures an image of a contract document placed on the platen and a projector projects the resultant image data as well as a check box used for confirming that the content has been checked, onto the platen. In such a case, an insurance company employee and a client can simultaneously operate the operation screen. However, the check box should be allowed to be checked when the client has agreed to the presentation given by the employee, and should not be freely checked by the employee.

### SUMMARY OF THE INVENTION

The present invention is directed to a technique capable of limiting, for each operation item, an operator who can operate the item in a system in which a plurality of operators can simultaneously operate a single operation screen including a plurality of the operation items.

The present invention is directed to a data processing apparatus in which an operation screen including a plurality of operation items can be simultaneously operated by a first operator and a second operator, includes a projection unit configured to project the operation screen onto a predetermined area, a determination unit configured to determine whether an operator who has performed an operation on the operation screen projected by the projection unit is the first operator or the second operator, and a control unit configured to perform control so as to validate, when the determination unit determines that the operator is the first operator, an operation on a first operation item in the operation screen and an operation on a second operation item in the operation screen, and so as to validate, when the determination unit determines that the operator is the second operator, an operation on the first operation item, and to invalidate an operation on the second operation item.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration of a camera scanner.

FIGS. 2A, 2B, and 2C are diagrams illustrating an example of an outer view of the camera scanner.

FIG. 3 is a block diagram illustrating an example of a hardware configuration of a controller unit and the like.

FIG. 4 is a block diagram illustrating an example of a functional configuration of the camera scanner.

FIGS. 5A, 5B, 5C, and 5D are a flowchart and the like illustrating an example of processing executed by a range image acquisition unit.

FIG. 6 is a flowchart illustrating an example of processing executed by a gesture recognition unit.

FIGS. 7A, 7B, and 7C are schematic diagrams illustrating fingertip detection processing.

FIGS. 8A, 8B, and 8C are diagrams each illustrating an example of used states of the camera scanner.

FIG. 9 is a flowchart illustrating an example of processing executed by a main control unit according to a first exemplary embodiment.

FIGS. 10A, 10B, 10C, 10D, 10E, 10F, and 10G are diagrams each illustrating an example of an operation screen and how the screen is operated.

FIGS. 11A, 11B, 11C, 11D, 11E, 11F, and 11G are a flowchart and the like illustrating an example of processing executed by a gesture operator identification unit according to the first exemplary embodiment.

FIG. 12 is a diagram illustrating an example of an authority management table according to the first exemplary embodiment.

FIGS. 13A, 13B, 13C, and 13D are diagrams each illustrating an example of the operation screen.

FIG. 14 is a flowchart illustrating an example of processing executed by a main control unit according to a second exemplary embodiment.

FIGS. 15A, 15B, and 15C are diagrams each illustrating away state checking processing according to the second exemplary embodiment.

FIG. 16 is a diagram illustrating an example of an authority management table according to the second exemplary embodiment.

FIG. 17 is a flowchart illustrating an example of processing executed by a main control unit according to a third exemplary embodiment.

FIGS. 18A, 18B, and 18C are diagrams each illustrating an example of operations performed for execution limiting checking according to the third exemplary embodiment.

FIG. 19 is a diagram illustrating an example of an authority management table according to the third exemplary embodiment.

### DESCRIPTION OF THE EMBODIMENTS

Exemplary embodiments for implementing the present invention are described below with reference to the drawings.

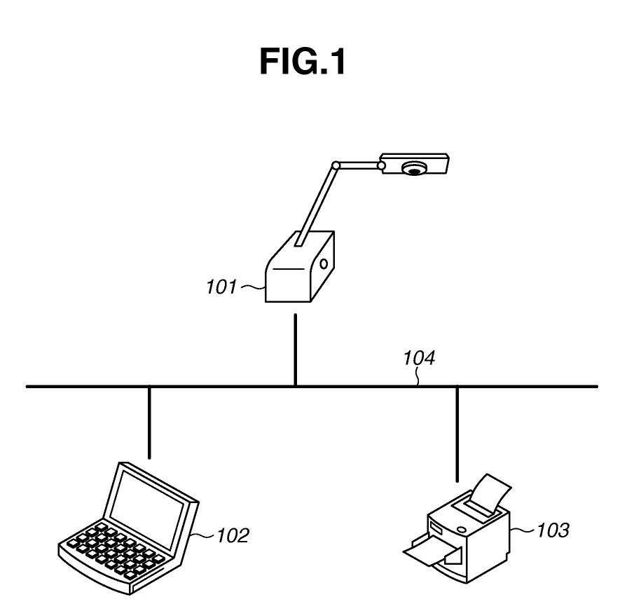

FIG. 1 is a diagram illustrating a system configuration including a camera scanner 101 according to a first exemplary embodiment.

As illustrated in FIG. 1, the camera scanner 101 is connected to a host computer 102 and a printer 103 via a network 104. The camera scanner 101 is an example of an image processing apparatus. In the system configuration illustrated in FIG. 1, a scanning function of reading an image with the camera scanner 101 and a printing function of outputting the scan data obtained by the camera scanner 101 to the printer 103 can be implemented through an instruction from the host computer 102. Furthermore, the scanning function and the printing function can be implemented through a direct instruction to the camera scanner 101 without involving the host computer 102.

### (Configuration of Camera Scanner)

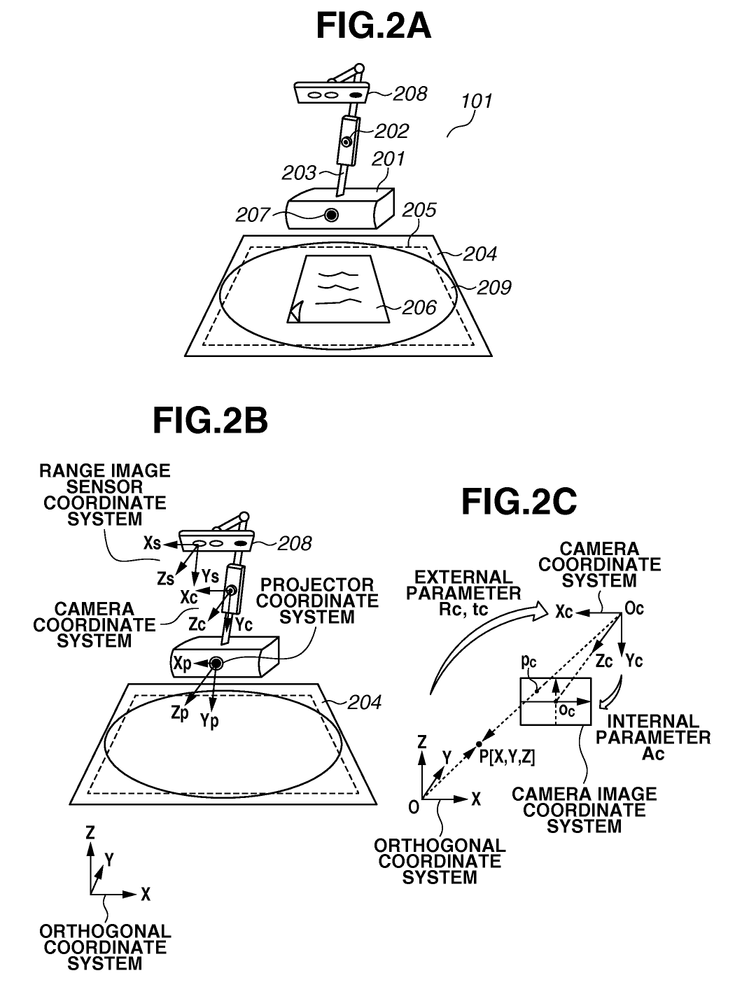

FIGS. 2A, 2B, and 2C are diagrams illustrating an example of an outer view of the camera scanner 101 according to the present exemplary embodiment.

As illustrated in FIG. 2A, the camera scanner 101 includes a controller unit 201, a camera unit 202, an arm unit 203, a short focus projector 207 (hereinafter, referred to as a projector 207), and a range image sensor 208. The controller unit 201 as the main body of the camera scanner 101, the camera unit 202 that performs image capturing, the projector 207, and the range image sensor 208 are connected to each other via the arm unit 203. The arm unit 203 can be bent and stretched with a joint. The camera unit 202 is an example of an image capturing unit that captures an image. The projector 207 is an example of a projection unit that projects an operation screen (operation display) described below on which a user performs an operation. The range image sensor 208 is an example of a range image acquisition unit that acquires a range image.

FIG. 2A further illustrates a platen 204 on which the camera scanner 101 is mounted. The camera unit 202 and the range image sensor 208 each have a lens directed toward the platen 204, and can read an image in a read area 205 surrounded by a dashed line. In an example illustrated in FIG. 2, a document 206 placed in the read area 205 can be read by the camera scanner 101. A turntable 209 is provided on the platen 204. The turntable 209 can rotate in accordance with an instruction from the controller unit 201, so that an angle between an object (subject) on the turntable 209 and the camera unit 202 can be changed.

The camera unit 202 may capture an image with a fixed resolution, but is preferably capable of capturing an image with a high resolution and a low resolution.

The camera scanner 101 may further include a liquid crystal display (LCD) touch panel 330 and a speaker 340 (not illustrated in FIG. 2).

FIG. 2B illustrates coordinate systems in the camera scanner 101. Coordinate systems such as a camera coordinate system, a range image coordinate system, and a projector coordinate system are defined for respective hardware devices in the camera scanner 101, with an image plane captured by the camera unit 202 and an RGB camera 363 of the range image sensor 208 or projected by the projector 207 being defined as an XY plane, and a direction orthogonal to the image plane being defined as a Z direction. Furthermore, an orthogonal coordinate system is defined in such a manner that a plane including the platen 204 is set as an XY plane and an upward direction orthogonal to the XY plane is set as a Z axis. Thus, pieces of three-dimensional data on the respective coordinate systems, independent from each other, can be expressed in a unified manner.

FIG. 2C illustrates one example of a case where a coordinate system is converted. More specifically, FIG. 2C illustrates a relationship among the orthogonal coordinate system, a space defined by the camera coordinate system with the camera unit 202 at the center, and the image plane captured by the camera unit 202. A three-dimensional point P[X,Y,Z] in the orthogonal coordinate system can be converted in to a three-dimensional point Pc[Xc,Yc,Zc] in the camera coordinate system with the following formula

[X_{c},Y_{c},Z_{c}]^{T}[R^{c}|t^{c}][X,Y,Z,1]^{T} (1)

In formula (1), Rc and tc are constituted of external parameters obtained respectively based on an orientation (rotation) and a position (translation) of a camera with respect to the orthogonal coordinate system. Thus, Rc and tc are respectively referred to as a 3×3 rotation matrix and a translation vector. A three-dimensional point defined in the camera coordinate system can be converted into a three-dimensional point in the orthogonal coordinate system with the following formula

[X,Y,Z]^{T}=└R_{c}⁻¹t_{c}┘[X_{c},Y_{c},Z_{c},1]^{T} (2)

A two-dimensional camera image plane captured by the camera unit 202 is obtained by the camera unit 202, by converting three-dimensional information in a three-dimensional space into two-dimensional information. More specifically, the plane is obtained by performing perspective projection conversion on a three-dimensional point Pc[Xc,Yc,Zc] on the camera coordinate system into two-dimensional coordinates pc[xp,yp] on the camera image plane with the following formula (3):

λ[xₚ,yₚ,1]T=A[X_{c},Y_{c},Z_{c}]T (3)

In formula (3), A is referred to as a camera internal parameter that is a 3×3 matrix expressed by a focal distance, an image center, and the like.

With formulae (1) and (3) described above, a three-dimensional point group expressed by the orthogonal coordinate system can be converted into three-dimensional point group coordinates on the camera coordinate system and into the camera image plane. It is assumed that the internal parameter of each hardware device and a position and an orientation (external parameter) of the hardware device with respect to the orthogonal coordinate system are calibrated in advance with a known calibration method. The term “three-dimensional point group” hereinafter represents three-dimensional data on the orthogonal coordinate system unless otherwise specified.

### (Hardware Configuration of Controller of Camera Scanner)

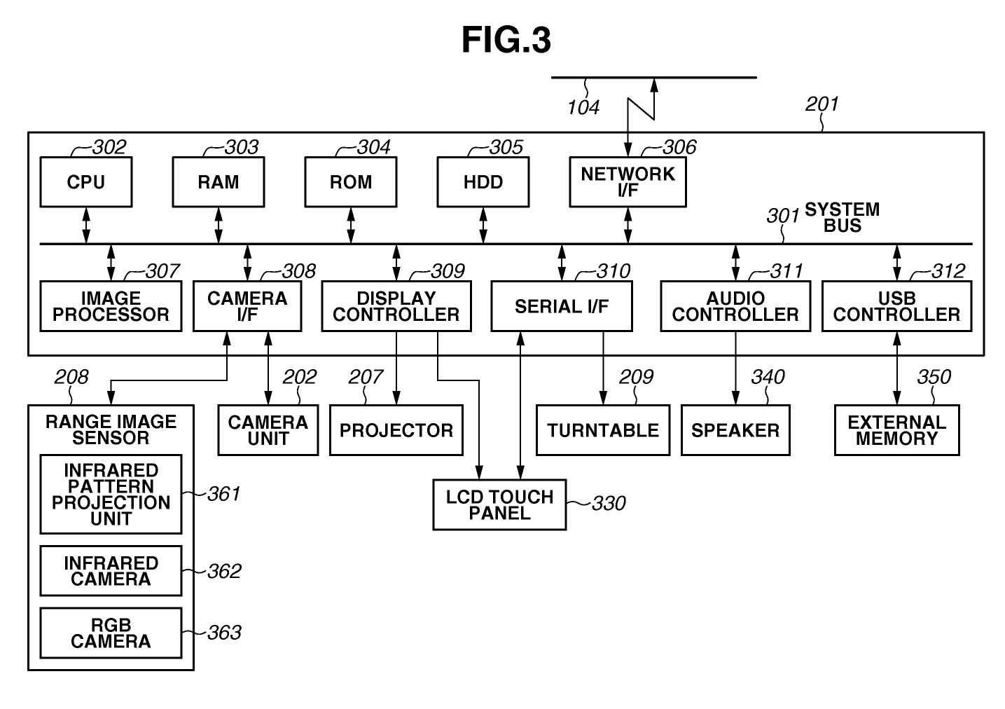

FIG. 3 is a block diagram illustrating an example of a hardware configuration of the controller unit 201 as a main body of the camera scanner 101 and the like.

As illustrated in FIG. 3, the controller unit 201 includes a central processing unit (CPU) 302, a random access memory (RAM) 303, a read only memory (ROM) 304, a hard disk drive (HDD) 305, a network I/F 306, and an image processor 307 connected to a system bus 301. The controller unit 201 further includes a camera I/F 308, a display controller 309, a serial I/F 310, an audio controller 311, and a USB controller 312.

The CPU 302 controls an operation of the entire controller unit 201. The RAM 303 is a volatile memory. The ROM 304 is a nonvolatile memory and stores a boot program for the CPU 302. The HDD 305 has a larger capacity than the RAM 303, and stores a control program, for the camera scanner 101, executed by the controller unit 201. When the CPU 302 executes a program stored in the ROM 304 and the HDD 305, a functional configuration of the camera scanner 101 and processing (information processing) in flowcharts described below are implemented.

The CPU 302 executes the boot program stored in the ROM 304, when the camera scanner 101 is turned ON or the like to be started. The boot program is used for the CPU 302 to read out the control program stored in the HDD 305, and load the control program onto the RAM 303. After executing the boot program, the CPU 302 executes the control program loaded on the RAM 303, and thus performs the control. The RAM 303 further stores data used in the operation based on the control program. Such data is written to and read from the RAM 303 by the CPU 302. The HDD 305 may further store various settings required for the operation based on the control program and image data generated by a camera input. Such settings and data are written to and read from the HDD 305 by the CPU 302. The CPU 302 communicates with other apparatuses on the network 104 through the network I/F 306.

The image processor 307 reads out and processes the image data stored in the RAM 303, and writes the resultant image data to the RAM 303. The image processor 307 executes image processing such as rotation, magnification, and color conversion.

The camera I/F 308 is connected to the camera unit 202 and the range image sensor 208. In response to an instruction from the CPU 302, the camera I/F 308 acquires image data from the camera unit 202 and range image data from the range image sensor 208, and writes them to the RAM 303. The camera I/F 308 transmits a control command from the CPU 302 to the camera unit 202 and the range image sensor 208, so that the settings of the camera unit 202 and the range image sensor 208 are performed.

The controller unit 201 may further include at least one of a display controller 309, a serial I/F 310, an audio controller 311, and a universal serial bus (USB) controller 312.

The display controller 309 is connected to the projector 207 and an LCD touch panel 330, and controls displaying of the image data according to an instruction from the CPU 302.

The serial I/F 310 inputs and outputs a serial signal. The serial I/F 310 is connected to the turntable 209, and transmits instructions for starting and ending rotation and for setting a rotation angle from the CPU 302 to the turntable 209. The serial I/F 310 is connected to the LCD touch panel 330. When the LCD touch panel 330 is pressed, the CPU 302 acquires coordinates of the pressed portion through the serial I/F 310.

The audio controller 311 is connected to the speaker 340, and converts audio data into an analog audio signal and outputs audio sound through the speaker 340, under an instruction from the CPU 302.

The USB controller 312 controls an external USB device according to an instruction from the CPU 302. The USB controller 312 is connected to an external memory 350 such as a USB memory and a secure digital (SD) card, and writes and reads data to and from the external memory 350.

### (Functional Configuration of Camera Scanner)

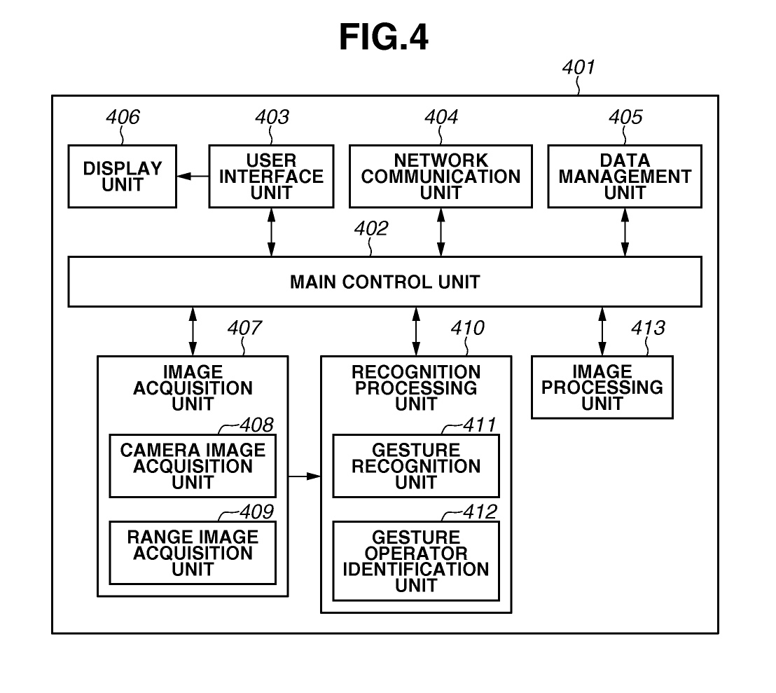

FIG. 4 is a block diagram illustrating an example of a functional configuration 401 of the camera scanner 101 implemented when the CPU 302 executes the control program. As described above, the control program for the camera scanner 101 is stored in the HDD 305, and is loaded onto the RAM 303 to be executed by the CPU 302 when the camera scanner 101 is started.

A main control unit 402, mainly in charge of the control, controls other modules in the functional configuration 401.

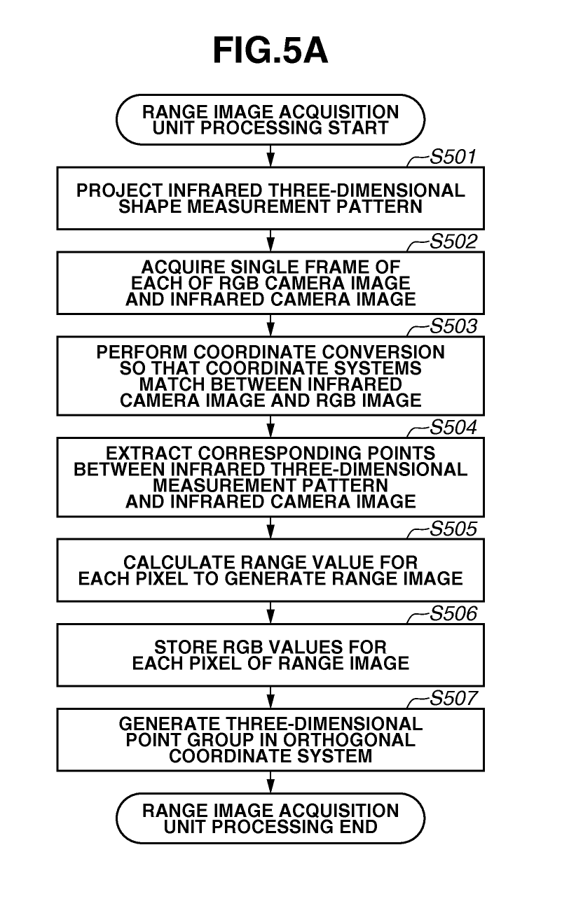

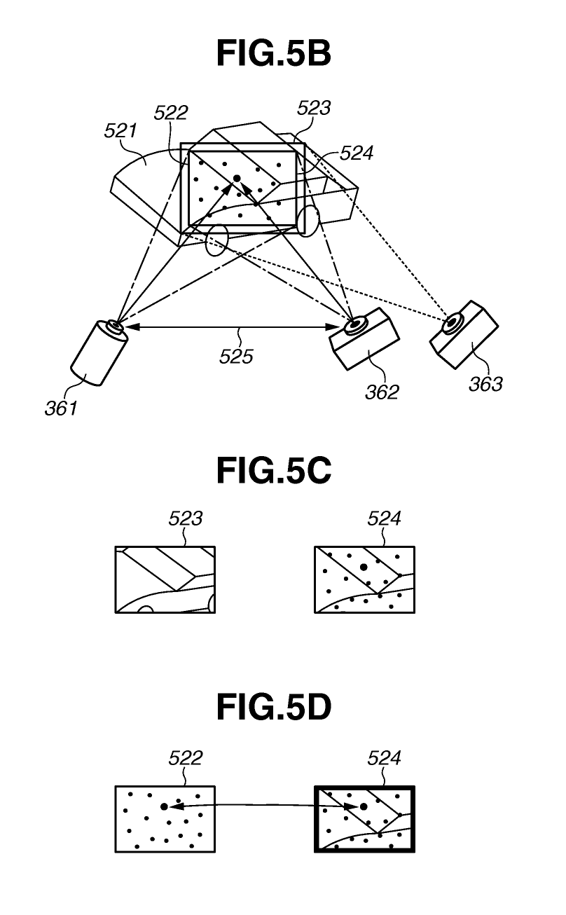

The image acquisition unit 407 is a module that performs image input processing, and includes a camera image acquisition unit 408 and a range image acquisition unit 409. The camera image acquisition unit 408 acquires image data, output from the camera unit 202 through the camera I/F 308, and stores the image data in the RAM 303 (captured image acquisition processing). The range image acquisition unit 409 acquires the range image data, output from the range image sensor 208 through the camera I/F 308, and stores the range image data in the RAM 303 (range image acquisition processing). The processing executed by the range image acquisition unit 409 is described below in detail with reference to FIG. 5.

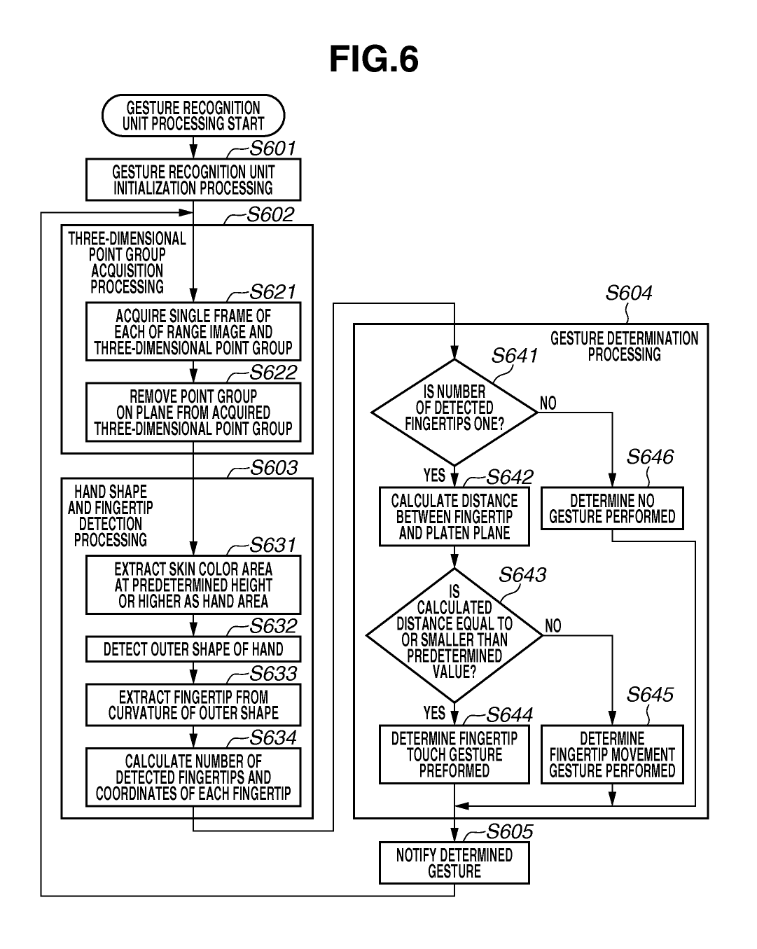

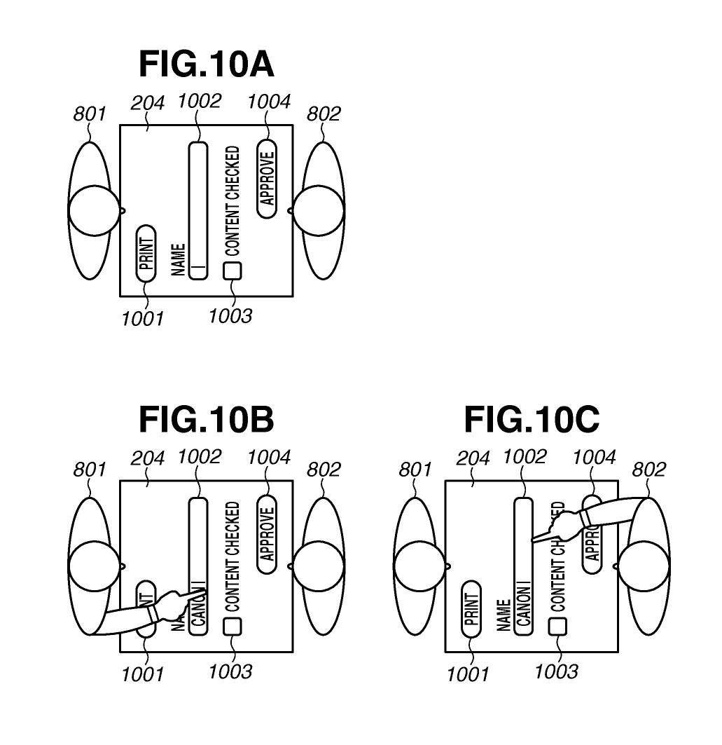

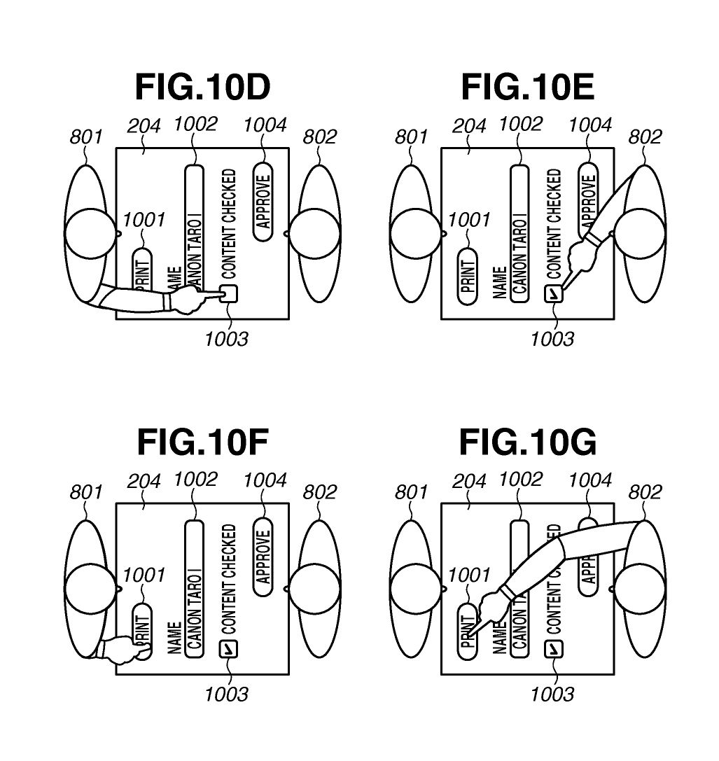

A recognition processing unit 410 is a module that detects and recognizes a movement of an object on the platen 204, from the image data acquired by the camera image acquisition unit 408 and the range image acquisition unit 409. The recognition processing unit 410 includes a gesture recognition unit 411 and a gesture operator identification unit 412. The gesture recognition unit 411 sequentially acquires images on the platen 204 from the image acquisition unit 407. Upon detecting a gesture such as touching, the gesture recognition unit 411 notifies the main control unit 402 of the detected gesture. The gesture operator identification unit 412 identifies an operator who has performed the gesture detected by the gesture recognition unit 411, and notifies the main control unit 402 of the identified operator. The processing executed by the gesture recognition unit 411 and the gesture operator identification unit 412 is described in detail below with reference to FIGS. 6 and 10.

An image processing unit 413 provides a function with which the image processor 307 analyzes the images acquired from the camera unit 202 and the range image sensor 208. The gesture recognition unit 411 and the gesture operator identification unit 412 also execute processing using a function of the image processing unit 413.

A user interface unit 403 receives a request from the main control unit 402 and generates a graphic user interface (GUI) parts such as a message and a button. The user interface unit 403 requests a display unit 406 to display the generated GUI parts. The display unit 406 displays the requested GUI parts requested to the projector 207 or the LCD touch panel 330 through the display controller 309. The projector 207 is directed toward the platen 204, and thus can project the GUI parts onto the platen 204. Thus, the platen 204 includes a projection area onto which the image is projected by the projector 207. The user interface unit 403 receives a gesture operation such as touching recognized by the gesture recognition unit 411 or an input operation from the LCD touch panel 330 through the serial I/F 310 as well as coordinates related to the received operation. The user interface unit 403 determines an operation content (such as a pressed button), based on the association between the displayed content on the operation screen and the operated coordinates. The user interface unit 403 notifies the main control unit 402 of the operation content, whereby the operation made by the operator is received.

A network communication unit 404 performs communications based on TCP/IP with other apparatuses on the network 104 through the network I/F 306.

A data management unit 405 stores various data, such as operation data generated by the CPU 302 executing the control program, in a predetermined area on the HDD 305, and manages the data.

(Description about Range Image Sensor and Range Image Acquisition Unit)

The range image sensor 208 is an infrared pattern projection method range image sensor and includes an infrared pattern projection unit 361, an infrared camera 362, and the RGB camera 363, as illustrated in FIG. 3. The infrared pattern projection unit 361 projects a three-dimensional measurement pattern, using infrared (invisible to people), onto a target object. The infrared camera 362 reads the three-dimensional measurement pattern that has been projected onto the target object. The RGB camera 363 converts visible light (visible to people) into an RGB signal.

Processing executed by the range image acquisition unit 409 is described with reference to a flowchart in FIG. 5A. FIGS. 5B to 5D illustrate a method of measuring the range image using the pattern projection system.

When the processing starts, in step S501, the range image acquisition unit 409 projects an infrared three-dimensional shape measurement pattern 522 onto a target object 521 by using the infrared pattern projection unit 361 as illustrated in FIG. 5B.

In step S502, the range image acquisition unit 409 acquires an RGB camera image 523 as an image of the target object 521 captured by the RGB camera 363 and an infrared camera image 524 as an image of a three-dimensional shape measurement pattern 522 projected by the infrared camera 362 in step S501. The infrared camera 362 and the RGB camera 363 are installed at different positions, and thus respectively capture the RGB camera image 523 and the infrared camera image 524, as two images different from each other in the imaging area as illustrated in FIG. 5C.

In step S503, the range image acquisition unit 409 converts the coordinate system of the infrared camera 362 into the coordinate system of the RGB camera 363, so that the coordinate systems match between the infrared camera image 524 and the RGB camera image 523. It is assumed that the relative positions and the internal parameters of the infrared camera 362 and the RGB camera 363 have been given by the calibration processing executed in advance.

In step S504, the range image acquisition unit 409 extracts the corresponding points between the three-dimensional shape measurement pattern 522 and the infrared camera image 524 that has been subjected to the coordinate conversion in step S503 as illustrated in FIG. 5D. For example, the range image acquisition unit 409 searches for, on the three-dimensional shape measurement pattern 522, a point on the infrared camera image 524, and when such a point is found, the corresponding points are associated with each other. Alternatively, the range image acquisition unit 409 may search for, on the three-dimensional shape measurement pattern 522, a peripheral pattern of a pixel in the infrared camera image 524, and thus most similar portions may be associated with each other.

In step S505, the range image acquisition unit 409 calculates a distance from the infrared camera 362, based on triangulation with a straight line, connecting the infrared pattern projection unit 361 and the infrared camera 362, serving as a base line 525. The range image acquisition unit 409 calculates the distance between the target object 521 and the infrared camera 362 at a position corresponding to the pixel successfully associated in step S504, and stores the distance as a pixel value for the pixel. On the other hand, the range image acquisition unit 409 stores an invalid value for a pixel having failed to be associated as a portion in which measurement of the distance has failed. The range image acquisition unit 409 performs the processing described above on all the pixels in the infrared camera image 524 that have been subjected to the coordinate conversion in step S503, and thus generates a range image of which each pixel is provided with the distance value (distance information).

In step S506, the range image acquisition unit 409 stores RGB values of the RGB camera image 523 for each pixel of the range image, whereby a range image in which each pixel has four values including the R, G, B, and distance values, is formed. The range image thus acquired is based on the range image sensor coordinate system defined for the RGB camera 363 of the range image sensor 208.

Then, in step S507, the range image acquisition unit 409 converts the distance information obtained based on the range image sensor coordinate system as described above with reference to FIG. 2B into a three-dimensional point group on the orthogonal coordinate system. The term three-dimensional point group hereinafter represents the three-dimensional point group in the orthogonal coordinate system unless otherwise specified.

The range image sensor 208 may employ systems other than the infrared pattern projection system employed in the present exemplary embodiment described above. For example, a stereo system in which stereographic three-dimensional viewing is achieved with two RGB cameras or a Time of Flight (TOF) system in which a distance is measured by detecting a flight time of a laser beam may be employed.

(Description about Gesture Recognition Unit)

The processing executed by the gesture recognition unit 411 is described in detail with reference to a flowchart in FIG. 6.

When the processing starts, in step S601 in FIG. 6, the gesture recognition unit 411 executes initialization processing. In the initialization processing, the gesture recognition unit 411 acquires one frame of the range image from the range image acquisition unit 409. At the starting point of the processing executed by the gesture recognition unit 411, no target object is placed on the platen 204. Thus, a plane of the platen 204 is recognized as an initial state. More specifically, the gesture recognition unit 411 extracts the largest plane from the acquired range image, calculates the position and a normal vector of the plane (hereinafter, referred to as plane parameters of the platen 204), and stores the plane parameters in the RAM 303.

In step S602, the gesture recognition unit 411 acquires the three-dimensional point group of an object on the platen 204 through steps S621 and S622.

In step S621, the gesture recognition unit 411 acquires one frame of each of the range image and the three-dimensional point group from the range image acquisition unit 409.

In step S622, the gesture recognition unit 411 uses the plane parameters of the platen 204 to remove a point group on the plane including the platen 204 from the acquired three-dimensional point group.

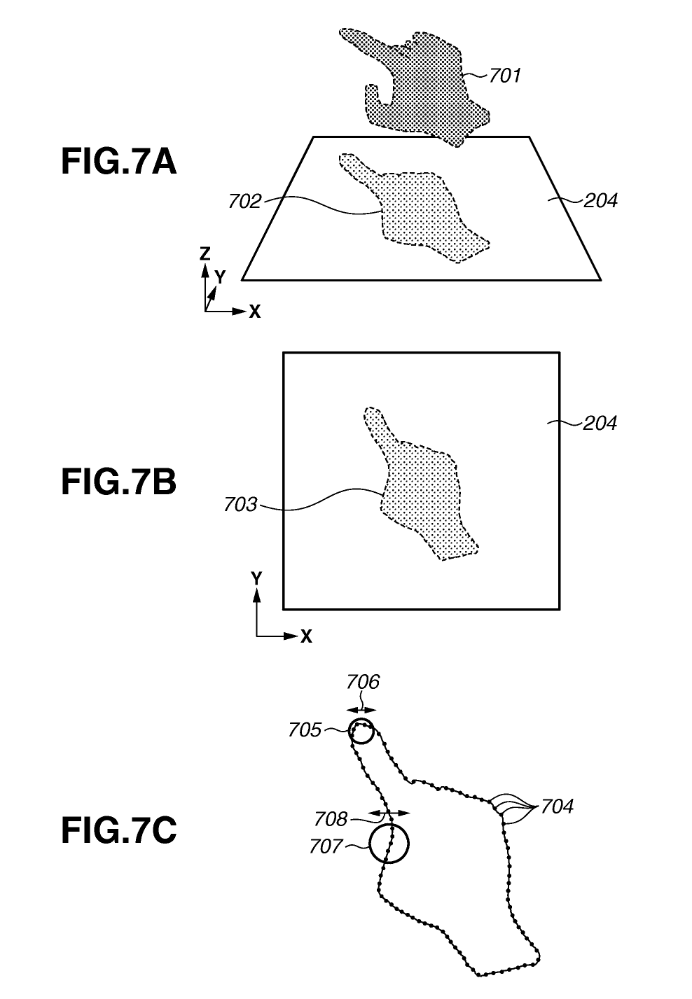

In step S603, the gesture recognition unit 411 executes processing of detecting a hand shape and a fingertip of the user from the acquired three-dimensional point group, through steps S631 to S634. The processing executed in step S603 is described with reference to FIG. 7 schematically illustrating fingertip detection processing.

In step S631, the gesture recognition unit 411 extracts a skin-colored three-dimensional point group 701 in FIG. 7A, at a predetermined height or higher from the plane including the platen 204, from the three-dimensional point group acquired in step S602.

In step S632, the gesture recognition unit 411 generates a two-dimensional image 702, illustrated in FIG. 7A, of the extracted three-dimensional point group, representing the hand, projected onto the plane of the platen 204, to detect the outer shape of the hand. More specifically, the two-dimensional image 702 is obtained by projecting the coordinates of the point group using the plane parameters of the platen 204. Furthermore, a two-dimensional image 703, as viewed in the Z axis direction, can be obtained by subtracting xy coordinate values from the projected three-dimensional point group as illustrated in FIG. 7B. At that time, the gesture recognition unit 411 stores information indicating correspondence relationship between points in the two-dimensional image projected on the plane of the platen 204 and points in the three-dimensional point group representing the hand.

In step S633, the gesture recognition unit 411 calculates a curvature of the outer shape at each of the points defining the detected outer shape of the hand, and detects a point, at which the curvature smaller than a predetermined value is calculated, as a fingertip. FIG. 7C is a diagram schematically illustrating a method of detecting a fingertip from a curvature of the outer shape. In the figure, for example, circles 705 and 707 are drawn that each include five adjacent ones of points 704 defining the outer shape of the two-dimensional image 703 projected on the plane of the platen 204. Such a circle is sequentially drawn for each of the point defining the outer shape as the center. The point, with which a circle with a diameter (for example, a diameter 706 and not a diameter 708) smaller than a predetermined value (small curvature), is detected as the fingertip. The number of adjacent points in each circle, which is five in this example, is not particularly limited. The fingertip may also be detected by performing ellipse fitting on the outer shape instead of using the curvature as in the example described above.

In step S634, the gesture recognition unit 411 calculates the number of detected fingertips and the coordinates of each fingertip. As described above, the correspondence relationship between points in the two-dimensional image, projected onto the platen 204, and points in the three-dimensional point group representing the hand is stored. Thus, the gesture recognition unit 411 can acquire the three dimensional coordinates of each fingertip. An image from which the fingertip is detected is not limited to the image of the three-dimensional point group projected onto the two-dimensional image as in the method described above. For example, the hand area may be extracted by background subtraction on the range image or from a skin color area in the RGB image, and the fingertip in the hand area may be detected by a method similar to that described above (such as calculation of the curvature of the outer shape). The coordinates of the fingertip detected in this case are two-dimensional coordinates on the two-dimensional image such as the RGB image or the range image. Thus, the gesture recognition unit 411 needs to convert the coordinates into the three dimensional coordinates on the orthogonal coordinate system by using the distance information on the range image at the coordinates. At that time, the fingertip point may be the center of the circle of curvature used for detecting the fingertip instead of the point on the outer shape as the fingertip point.

In step S604, the gesture recognition unit 411 executes gesture determination processing through steps S641 to S645 from the detected hand shape and fingertip.

In step S641, the gesture recognition unit 411 determines whether the number of the fingertips detected in step S603 is one. When the gesture recognition unit 411 determines that the number of the fingertips is not one (No in step S641), the processing proceeds to step S646. In step S646, the gesture recognition unit 411 determines that no gesture has been performed. On the other hand, when the gesture recognition unit 411 determines that the number of the fingertip is one (Yes in step S641), the processing proceeds to step S642. In step S642, the gesture recognition unit 411 calculates the distance between the detected fingertip and the plane including the platen 204.

In step S643, the gesture recognition unit 411 determines whether the distance calculated in step S642 is equal to or smaller than a predetermined value. When the distance is equal to or smaller than the predetermined value (Yes in step S643), the processing proceeds to step S644. In step S644, the gesture recognition unit 411 determines that a touch gesture of touching the platen 204 with the fingertip has been performed. When the distance calculated in step S642 is not equal to or smaller than the predetermined value (No in step S643), the processing proceeds to step S645. In step S645, the gesture recognition unit 411 determines that a gesture of moving the fingertip (gesture with the fingertip positioned above the platen 204 without touching) has been performed.

In step S605, the gesture recognition unit 411 notifies the main control unit 402 of the determined gesture, and then the processing returns to step S602 and the gesture recognition processing is repeated.

The gesture recognition unit 411 can recognize the gesture performed by the user based on the range image, through the processing described above.

(Description about Used States)

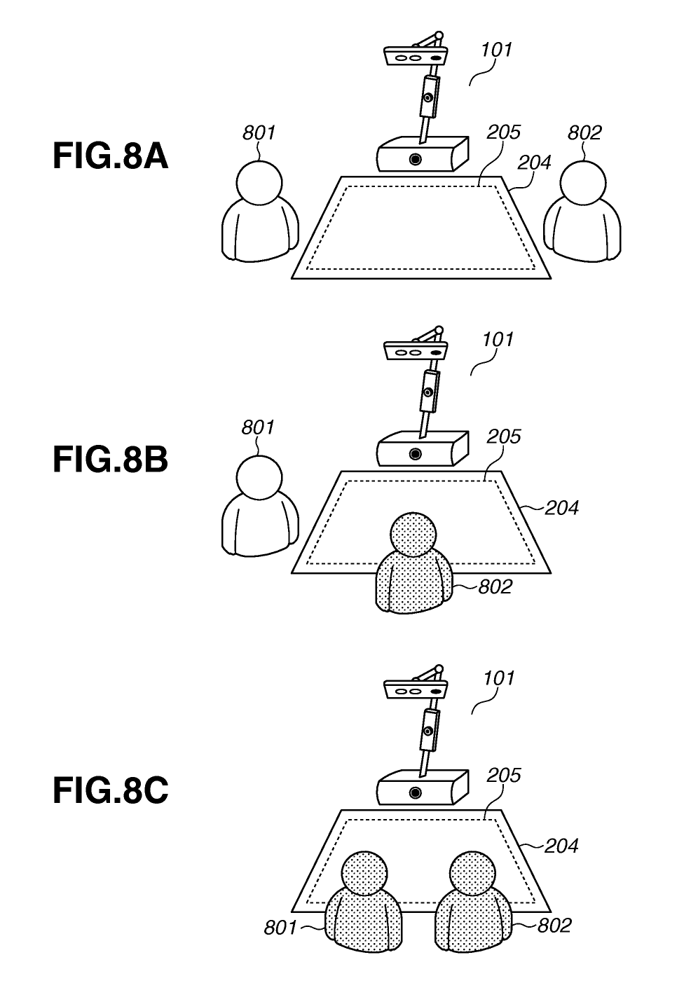

Used states of the camera scanner 101 are described with reference to FIGS. 8A, 8B, and 8C.

The present invention is expected to be applied to a case where a plurality of operators simultaneously operates the camera scanner 101. For example, the present invention can be applied to various cases such as a procedure for a contract and the like, a presentation for a product and the like, meetings, and education.

Operators of the camera scanner 101 are classified into a person (main operator) who operates the camera scanner 101 while giving an explanation, and a person (sub operator) who operates the camera scanner 101 while listening to the explanation.

In the procedure for a contract and the like, a presenter (main operator) and a client (sub operator) perform a procedure including checking of a contract content, inputting of necessary items, checking of input content, and approval. The necessary items can be input by either the presenter or the client as long as the client checks the input content in the end. On the other hand, only the client who has agreed to the presentation of the presenter can confirm that the input content is checked. Thus, the presenter is not allowed confirm that the content is checked on behalf of the client.

In an education case, a teacher (main operator) and a student (sub operator) perform a procedure including question setting, answering, correcting, explaining a suggested answer, and the like. The answers made by the student can be corrected by the teacher but not by the student. Meanwhile, the student can input the answers for the questions, and the teacher can input the suggested answers. It is an object of the present invention to implement an appropriate processing flow in the cases where the camera scanner 101 is operated by a plurality of operators, by appropriately giving authority to each operator.

FIGS. 8A, 8B, and 8C illustrate a state where two operators 801 and 802 are simultaneously operating the camera scanner 101. For example, the operators 801 and 802 may operate the camera scanner 101 in a state of sitting (or standing) in opposite sides to face each other as illustrated in FIG. 8A, in a state of sitting (or standing) on adjacent sides as illustrated in FIG. 8B, or in a state of sitting side by side to each other as illustrated in FIG. 8C. How the main operator and the sub operator are seated can be determined by the main operator when the operator logs in the system of the camera scanner 101. Alternatively, the face of the main operator registered in advance may be detected by using a face recognition technique and the like, and the other operator may be determined as the sub operator. Then, the arrangement can be determined based on the result. In addition, the camera scanner 101 can be used by three or more operators.

In a case described below, the operators (the main operator 801 and the sub operator 802) facing each other as illustrated in FIG. 8A use the camera scanner 101 for the contract procedure. The number of operators, how the operators are seated, and for what purpose the camera scanner 101 is used are not limited to this example.

(Description about Main Control Unit)

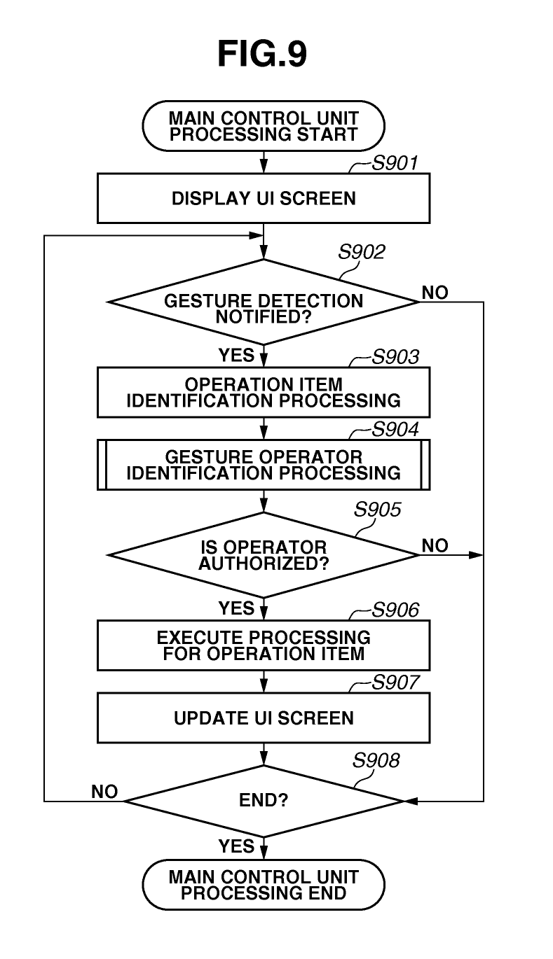

Processing executed by the main control unit 402 is described in detail with reference to a flowchart in FIG. 9.

When the processing starts, in step S901 in FIG. 9, the main control unit 402 causes the projector 207 to project and display the operation screen on the platen 204. FIG. 10 illustrates a state where the main operator 801 and the sub operator 802 are operating the operation screen projected and displayed on the platen 204. FIG. 10A illustrates an example of the operation screen. A print button 1001, a name input field 1002, a check box 1003, and an approve button 1004 are projected and displayed on the operation screen. The operators 801 and 802 can operate each operation item with a gesture operation. The operation items and the gesture operation performed on each operation item are not limited to those described above. For example, a software keyboard input operation, a gesture operation on displayed UI parts and images (such as an enlarged or downsized display, rotation, movement, and clipping) may be employed.

In step S902, the main control unit 402 determines whether a gesture detection notification has been input from the gesture recognition unit 411. Although the detected gesture in the description below is a touching operation on the platen 204, the other gesture operations may be detected. In a case illustrated in FIG. 10A, neither the main operator 801 nor the sub operator 802 is making an operation on the operation screen. Thus, the gesture recognition unit 411 has not detected the gesture (No in step S902), and thus the processing proceeds to step S908. On the other hand in cases illustrated in FIGS. 10B to 10G, the main operator 801 or the sub operator 802 is performing a gesture operation. Thus, the gesture recognition unit 411 has issued the notification indicating that the gesture is detected (Yes in step S902), and thus the processing proceeds to step S903.

In step S903, the main control unit 402 identifies the operation item selected by the gesture. The operation item identified as the selected item is the name input field 1002 in the cases illustrated in FIGS. 10B and 10C, the check box 1003 in the cases illustrated in FIGS. 10D and 10E, and the print button 1001 in the cases illustrated in FIGS. 10F and 10G.

In step S904, the main control unit 402 identifies the gesture operator who has performed the gesture detected in step S902. The main operator 801 is identified as the gesture operator in the cases illustrated in FIGS. 10B, 10D, and 10F. The sub operator 802 is identified as the gesture operator in the cases illustrated in FIGS. 10C, 10E, and 10G.

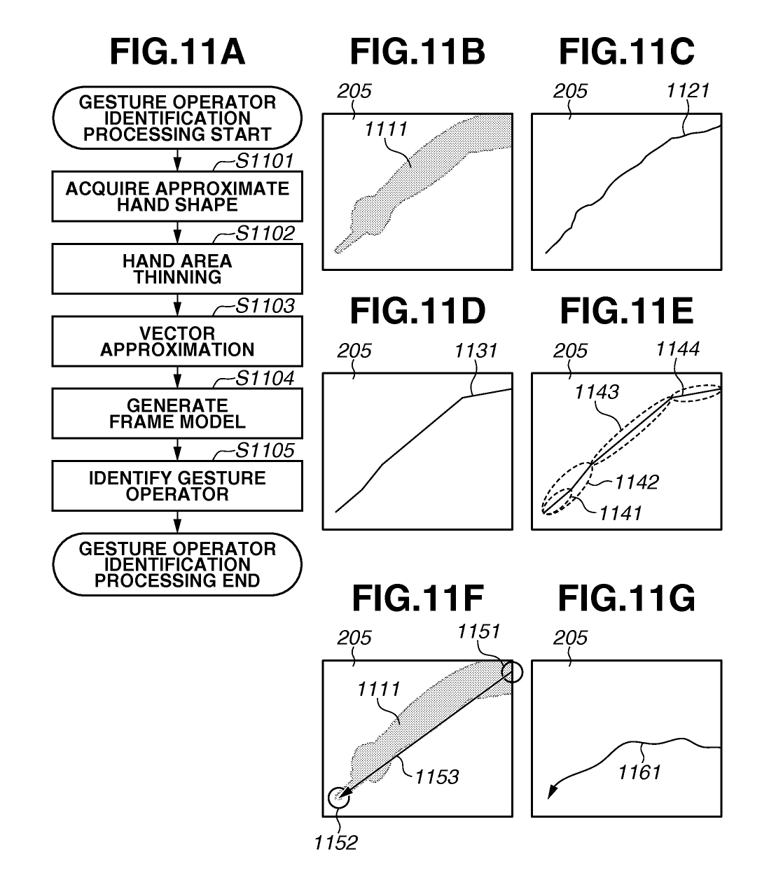

Now, the gesture operator identifying processing in step S904 is described with reference to FIGS. 11A to 11G. FIG. 11A is a flowchart illustrating an example of processing executed by the gesture operator identification unit 412. FIGS. 11B to 11F are diagrams illustrating the processing.

In step S1101 in FIG. 11A, the gesture operator identification unit 412 acquires an approximate hand shape. More specifically, the gesture operator identification unit 412 acquires the approximate hand shape by using background subtraction, frame subtraction, or the like on the image captured by the camera unit 202 or the range image sensor 208. Alternatively, the gesture operator identification unit 412 may acquire the approximate hand shape, generated when the touch gesture is detected by the gesture recognition unit 411 in step S632 in FIG. 6. For example, when the touch gesture as illustrated in FIG. 10G is performed, an approximate hand shape 1111 as illustrated in FIG. 11B is acquired.

Then, in step S1102, the gesture operator identification unit 412 executes thinning processing on the hand area to generate a center line 1121 of the hand area illustrated in FIG. 11C.

In step S1103, the gesture operator identification unit 412 executes vector approximation processing to generate a vector 1131 illustrated in FIG. 11D.

In step S1104, the gesture operator identification unit 412 generates a frame model of the hand area including a finger area 1141, a hand area 1142, a forearm area 1143, and an upper arm area 1144 as illustrated in FIG. 11E.

Finally, in step S1105, the gesture operator identification unit 412 estimates the direction in which the gesture operation has been performed based on the frame model acquired in step S1104, and identifies the gesture operator based on the positional relationship between the operators set in advance. Thus, the main control unit 402 can determine that the touch gesture has been performed by the operator 802 with the operator's right hand.

The method of identifying the gesture operator is not limited thereto, and the operator may be identified through other methods. For example, as illustrated in FIG. 11F, the gesture operator may be simply identified by using an orientation 1153 defined between a center of gravity position 1151 of the hand area and a fingertip position 1152 at image end portions. Alternatively, the gesture operator may be identified by generating a trail 1161 of the hand area from a fingertip movement gesture detected by the gesture recognition unit 411 as illustrated in FIG. 11G. Furthermore, the gesture operator can be identified by a human presence sensor (not illustrated) attached to the camera scanner 101 or by using face recognition or the like.

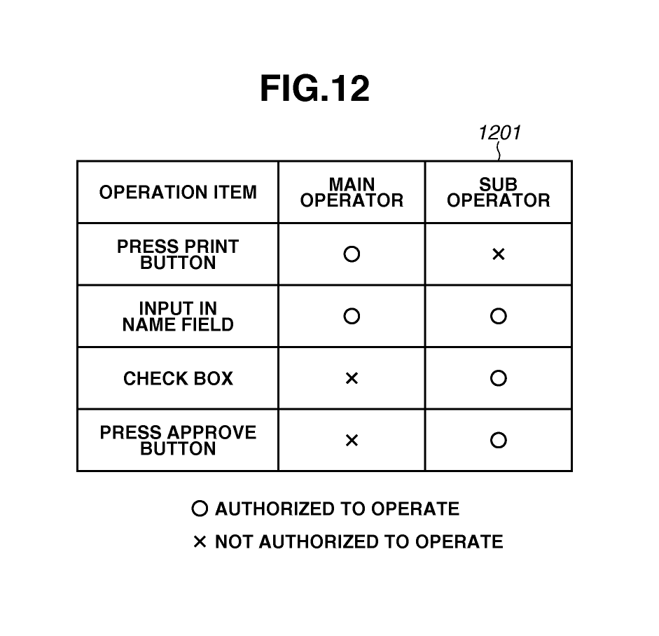

Referring back to FIG. 9, in step S905, the main control unit 402 determines whether the gesture operator is authorized to operate the operation item based on the operation item identified in step S903 and the gesture operator identified in step S904. When the main control unit 402 determines that the gesture operator is authorized (Yes in step S905), the processing proceeds to step S906. On the other hand, when the main control unit 402 determines that the gesture operator is not authorized (No in step S905), the processing proceeds to step S908. Whether the gesture operator is authorized is determined based on an authority management table 1201 as illustrated in FIG. 12. For example, both the main operator 801 and the sub operator 802 are authorized to operate the name input field 1002. Only the main operator 801 is authorized to operate the print button 1001, and only the sub operator 802 is authorized to operate the check box 1003 and the approve button 1004.

The method of determining whether the operator is authorized is not limited thereto. For example, each of the UI parts 1001 to 1004, corresponding to the respective operation items, may be provided with information indicating whether the part is authorized to be operated. Thus, whether the gesture operator is authorized to operate the corresponding item may be determined based on the information provided to the operated UI part and the information about the gesture operator.

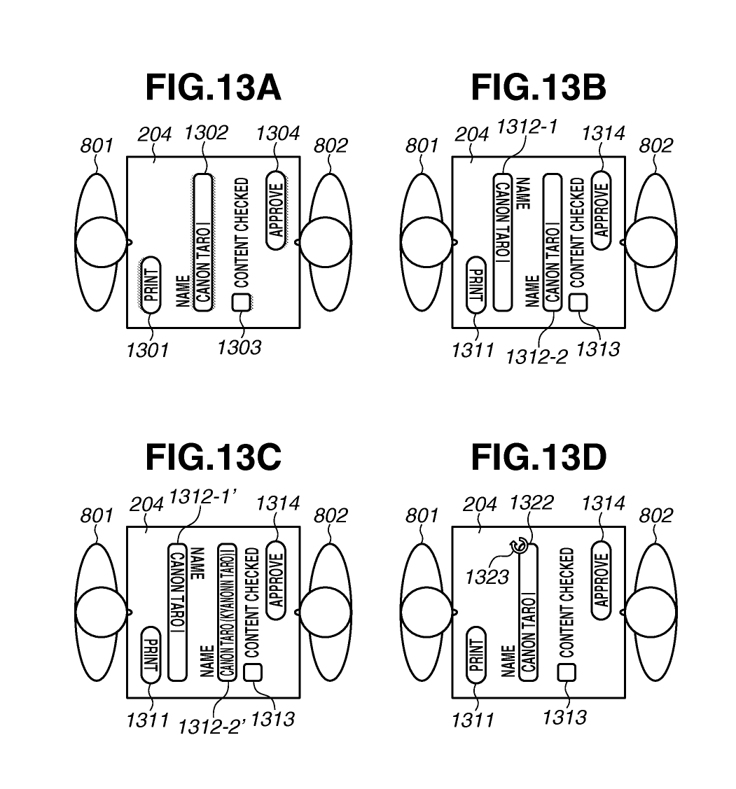

For example, a UI screen illustrated in FIG. 13A may be provided. More specifically, in the UI screen, the UI part that can be operated is shaded in a direction toward the authorized operator. The direction in which the operated UI part is shaded is detected from the image obtained from the camera image acquisition unit 408 or the range image acquisition unit 409. Thus, whether the gesture operator is authorized may be determined by determining whether the shaded direction matches the direction toward the gesture operator. More specifically, it can be determined that only the main operator 801 is authorized to operate the print button 1301 shaded toward the main operator 801. Furthermore, it can be determined that only the sub operator 802 is authorized to operate the check box 1303 and the approve button 1304 that are shaded toward the sub operator 802. Furthermore, it can be determined that both the main operator 801 and the sub operator 802 are authorized to operate the name input field 1302 that is shaded toward both the main operator 801 and the sub operator 802.

Alternatively, a UI screen as illustrated in FIG. 13B may be provided. More specifically, in the UI screen, a UI part, corresponding to the operation item that can be operated by each operator, has a displayed orientation that is easy to be seen by the operator. Thus, whether the gesture operator is authorized may be determined based on whether the orientation of the UI part is suitable for the orientation of the gesture operator, from the image acquired from the camera image acquisition unit 408 or the range image acquisition unit 409. In the example illustrated in FIG. 13B, the print button 1311 is oriented so as to be easily seen by the main operator 801. The check box 1313 and the approve button 1314 are oriented so as to be easily seen by the sub operator 802. As for the operation item that can be operated by a plurality of operators, the corresponding UI parts are respectively displayed for the operators. For example, the name input field 1312 is the operation item that can be operated by both the main operator 801 and the sub operator 802. Thus, a name input field 1312-1 and a name input field 1312-2 are respectively displayed for the main operator 801 and the sub operator 802. Here, a method needs to be provided with which a result of operating the operation item, which can be operated by a plurality of operators, by one operator is reflected on the operation item for the other operator. More specifically, when the main operator 801 performs an input operation on the name input field 1312-1, the input content is reflected on the name input field 1312-2 for the sub operator 802. Similarly, when the sub operator 802 performs an input operation on the name input field 1312-2, the input content is reflected on the name input field 1312-1 for the main operator 801. In this case, the same content may be displayed as illustrated in FIG. 13B, or the display method or the display content may be modified and displayed to be suitable for each operator as illustrated in FIG. 13C (1312-1′ and 1312-2′).

As illustrated in FIG. 13D, the operation item that can be operated by a plurality of operators (name input field 1322) may be displayed so as to orient the operation result in a direction toward an operator desired to present the operation result. More specifically, a method may be provided in which when a rotation button 1323 is operated, the display is rotated to be oriented to the other operator.

The authority management table 1201 illustrated in FIG. 12 may be combined with the display methods for the UI parts illustrated in FIG. 13.

Referring back to FIG. 9, in step S906, the main control unit 402 executes processing corresponding to the operation item identified in step S903. Then, in step S907, the main control unit 402 executes update processing for the UI screen in accordance with the executed processing corresponding to the identified operation item.

The name input field 1002 can be operated by both the main operator 801 and the sub operator 802. Therefore, as illustrated in FIGS. 10B and 10C, the input result is reflected on the name input field 1002 regardless of whether the item is operated by the main operator 801 or the sub operator 802. On the other hand, the check box 1003 can be operated by the sub operator 802 only. Therefore, a check mark is displayed when the sub operator 802 presses the check box 1003 as illustrated in FIG. 10E, but is not displayed when the main operator 801 presses the check box 1003 as illustrated in FIG. 10D. The print button 1001 can be operated by the main operator 801 only. Therefore, the printing by the printer 103 is performed when the main operator 801 presses the print button 1001 as illustrated in FIG. 10F, but is not performed when the sub operator 802 presses the print button 1001 as illustrated in FIG. 10G.

In step S908, the main control unit 402 determines whether the system is terminated. The processing from step S901 to step S908 is repeated until the main control unit 402 determines that the system is terminated. The main control unit 402 determines that the system is terminated when an end button projected and displayed on the operation screen is pressed or when a power button (not illustrated) on the main body of the camera scanner 101 is pressed (Yes in step S908).

As described above, according to the present exemplary embodiment, when the gesture operation is detected, the gesture operator is identified and whether execution is permitted is determined for each operation item on the operation screen. Thus, in the data processing system in which a plurality of operators can simultaneously operate a single operation screen, a displayed item that can be operated by one operator only can be prevented from being freely operated by the other operator.

In the first exemplary embodiment, a case where the operators are constantly in a range of the camera scanner 101 to perform the operations. However, in the contract procedure and the like, the presenter might temporarily leave the operator's seat. In such a case, it is not desirable that some of the operation items that can be operated by the client are operated when the presenter is away. Thus, in a second exemplary embodiment, a method is described in which when one operator has moved away from a position where the camera scanner 101 can be operated, the authority given to the other operator is changed.

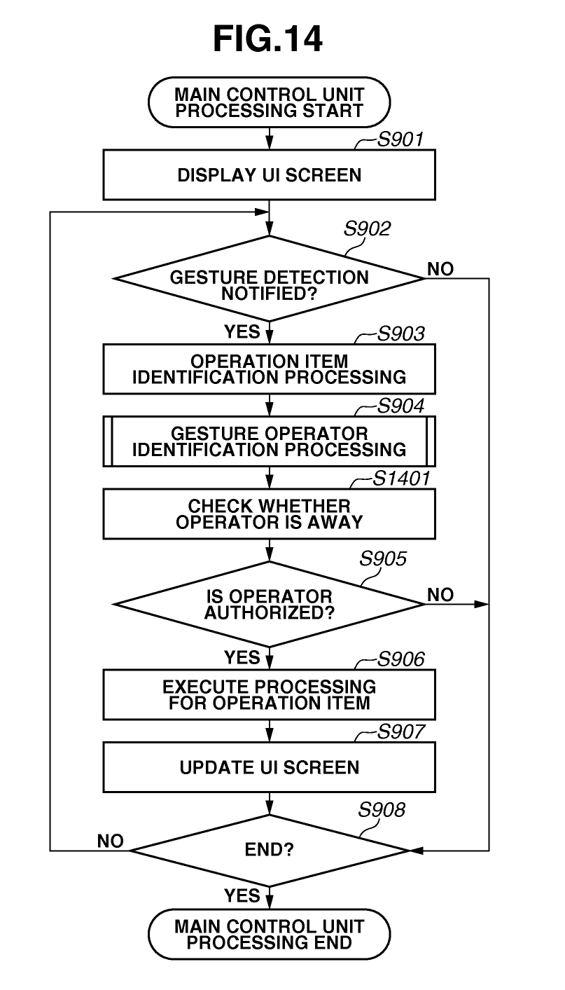

Processing executed in the camera scanner 101 according to the second exemplary embodiment is described with reference to FIGS. 14 to 16.

FIG. 14 is a flowchart illustrating a flow of the processing executed by the main control unit 402 according to the second exemplary embodiment. The flowchart in FIG. 1s different from that in FIG. 9 in that processing (step S1404) of checking an away state of the operator is added. Processing that is the same as that in FIG. 9 is denoted by the same step number and will not be described in detail.

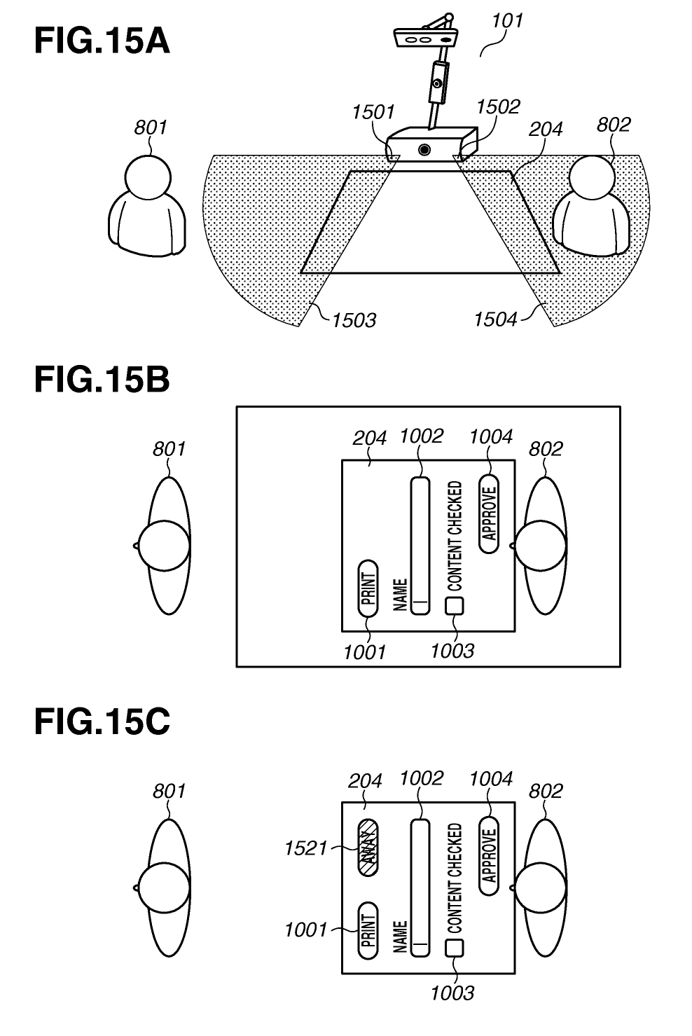

After identifying the operation item in step S903, and identifying the gesture operator in step S904, then in step S1401, the main control unit 402 checks the away state of an operator. More specifically, the away state is checked by detecting the absence of the operator from a person detection area 1503 or 1504 by a corresponding one of human presence sensors 1501 and 1502 attached to the camera scanner 101 as illustrated in FIG. 15A. In this case, the operator 801 has moved out of the person detection area 1503 and thus it can be determined that the operator 801 is away. Instead of using the two human presence sensors 1501 and 1502 as described above, the away state may be checked only with a single human presence sensor that can perform detection over the entire periphery of the camera scanner 101. Alternatively, the away state of each operator may be checked with a larger image capturing range achieved by changing zoom magnification of the camera unit 202 or the range image sensor 208 of the camera scanner 101. More specifically, it can be determined that the operator 801 is away when the operator 801 is not in an image 1511 captured with a wider range as illustrated in FIG. 15B. Furthermore, as illustrated in FIG. 15C, the operator 801 may press an away button 1521 when leaving the operator's seat, and the away state may be checked based on whether the away button 1521 has been pressed. The away state may be checked by using other various devices and units.

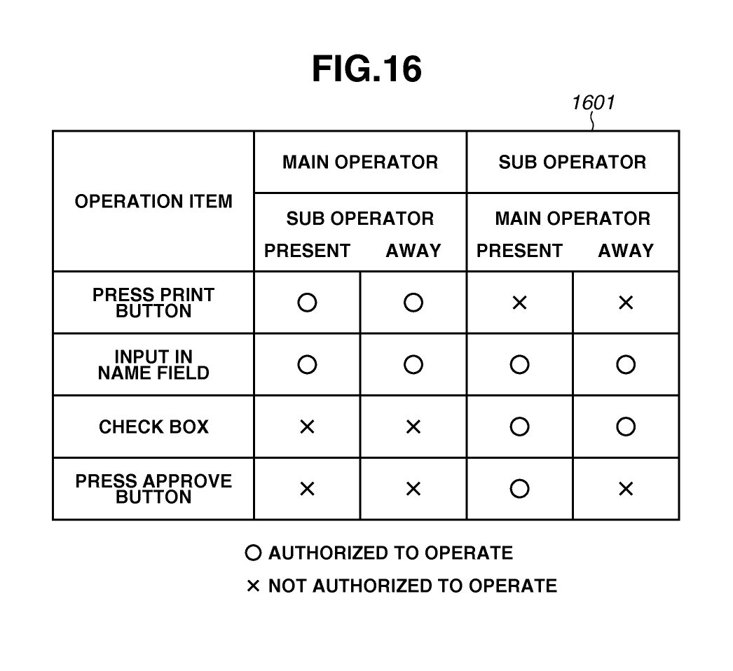

Then, in step S905, based on the operation item identified in step S903 and the away state checked in step S1401, the main control unit 402 determines whether the operator is authorized to operate the operation item. When the main control unit 402 determines that the operator is authorized (Yes in step S905), the processing proceeds to step S906. On the other hand, when the main control unit 402 determines that the operator is not authorized (No in step S905), the processing proceeds to step S908. Whether the operator is authorized is determined based on an authority management table 1601 illustrated in FIG. 16 that is different from the authority management table 1201 illustrated in FIG. 12 in that whether the authority is given is further determined based on whether the other operator is present or away. For example, the sub operator 802 can operate the check box 1003 regardless of whether the main operator 801 is present or away. On the other hand, the sub operator 802 can press the approve button 1004 only when the main operator 801 is present. In other words, the sub operator 802 is determined to be not authorized to operate the approve button 1004 when the main operator 801 is away. As a result, no approving processing is executed when the sub operator 802 presses the approve button 1004 in a state where the main operator 801 is away.

As described above, according to the present exemplary embodiment, when one operator is away from the position where the camera scanner 101 can be operated, the authority of the other operator can be limited. As a result, when one operator is away, the operation can be prevented from being freely performed by the other operator.

In the first and the second exemplary embodiments described above, when a certain operation item is operated by an authorized operator, processing corresponding to the operated item is immediately executed regardless of whether the item has been operated by the main operator or the sub operator. In this configuration, when a user such as a sub operator who is not used to the operation uses the camera scanner 101, an unintentional action might be erroneously recognized as a gesture operation, and an erroneous operation might be performed accordingly. Thus, in a third exemplary embodiment, a method for preventing such an erroneous operation, by the main operator controlling a timing at which the sub operator can operate the camera scanner 101, will be described.

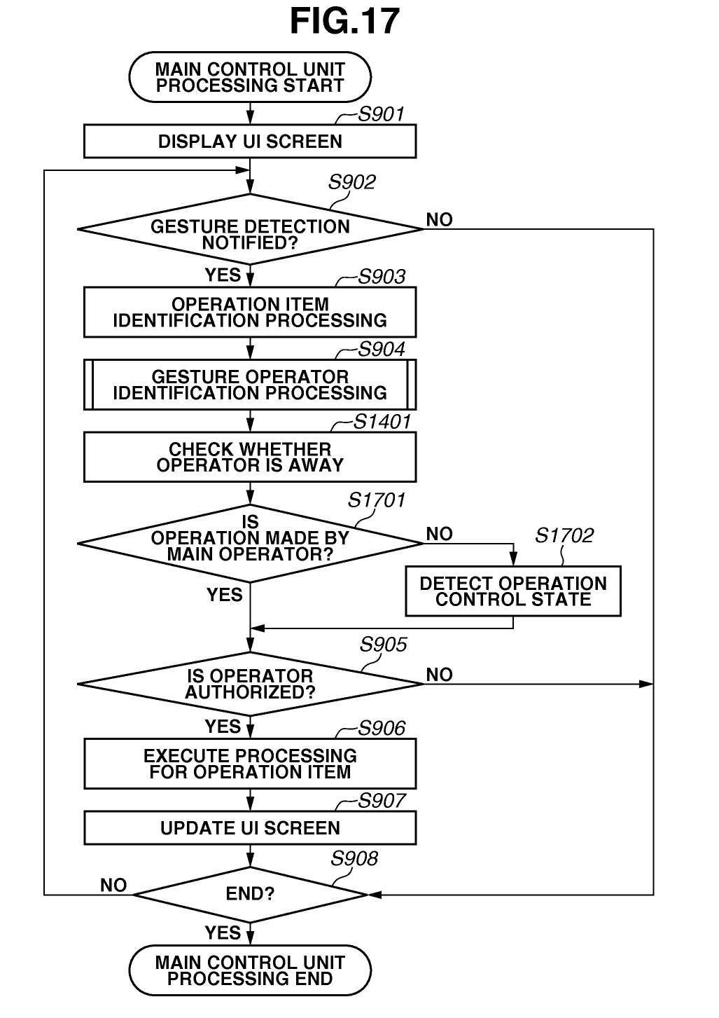

Processing executed in the camera scanner 101 according to the third exemplary embodiment is described with reference to FIGS. 17 to 19.

FIG. 17 is a diagram illustrating a flow of processing executed by the main control unit 402 according to the third exemplary embodiment. FIG. 17 is different from FIG. 14 in that processing in steps S1701 and S1702 is added. Processing that is the same as that in the first and the second exemplary embodiments is denoted by the same step number and will not be described in detail.

In step S1701, the main control unit 402 determines whether the gesture operator identified in step S904 is the main operator 801. When the gesture operator is the main operator 801 (Yes in step S801), the processing proceeds to step S905. In step S905, the authority checking processing is executed. On the other hand, when the gesture operator is the sub operator 802 (No in step S801), the processing proceeds to step S1702.

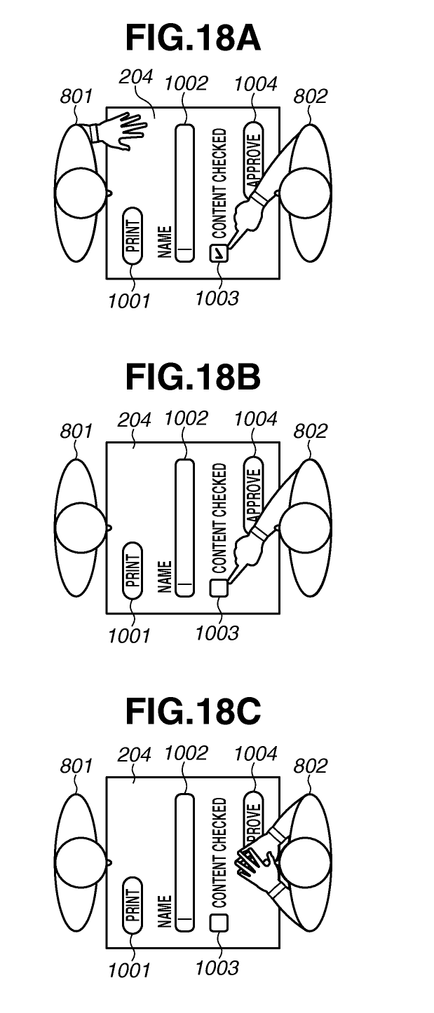

In step S1702, the main control unit 402 checks whether an instruction of permitting the sub operator 802 to perform an operation has been input. For example, the main control unit 402 may determine that the instruction of permitting the sub operator 802 to perform an operation has been input, when a hand of the main operator 801 is placed on a predetermined position on the platen as illustrated in FIG. 18A. In this case, whether the sub operator 802 is authorized to perform the operation can be determined by checking whether the hand of the main operator 801 is at the predetermined position. Alternatively, the sub operator 802 may be authorized to perform the operation when the main operator 801 presses an operation permission button (not illustrated). In this case, whether the sub operator 802 is authorized to perform the operation can be determined by checking whether the operation permission button is pressed.

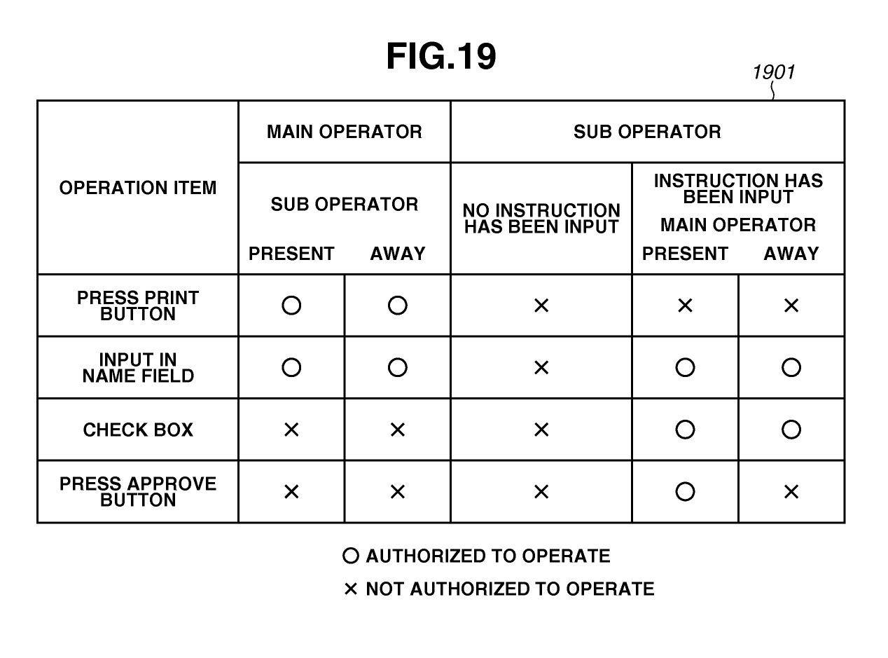

Then, in step S905, the main control unit 402 determines whether the identified operator is authorized based on an authority management table 1901 illustrated in FIG. 19. The authority management table 1901 is different from the authority management table 1601 illustrated in FIG. 16 in that a field related to the authority given to the sub operator 802 in a case where the operation permission instruction has not been issued by the main operator 801 is added. More specifically, an operation performed by the sub operator 802 on any operation item is invalidated when the operation permission instruction has not been input by the main operator 801. The authority is given to the sub operator 801 in the same way as that in the case of FIG. 16, when the operation permission instruction has been input by the main operator 801.

As described above, the sub operator 802 can press the check button in the case illustrated in FIG. 18A because the main operator 801 is placing the hand of main operator 801 on the predetermined position on the platen, and thus the operation permission instruction for the sub operator 802 has been input. On the other hand, it is determined that the operation permission instruction for the sub operator 802 has not been input and thus the operation by the sub operator 802 on the check button is invalidated in the case illustrated in FIG. 18B, because the hand of the main operator 801 is not placed on the predetermined position on the platen. By adding such a control, the operation can be restricted when a natural action of crossing hands on the screen performed by the sub operator 802 who is not used to the operation is recognized as the operation of pressing the approved button 1004.

As described above, according to the present exemplary embodiment, the main operator 801 can restrict an operation performed by the sub operator 802, and thus an erroneous operation can be prevented from being performed due to an unintentional operation performed by the sub operator 802.

In the exemplary embodiments described above, higher user operability can be achieved in a data processing apparatus such as the camera scanner 101, with which a plurality of operators can simultaneously operate a single operation screen including a plurality of operation items. More specifically, an operator who has performed a gesture operation on a projected operation screen is identified based on a range image. Then, whether the operation is permitted is controlled for each of the operation items in the operation screen in accordance with the identified operator. Thus, a display item that can be operated by one operator of a plurality of operators can be prevented from being freely operated by the other operator.

The exemplary embodiments are described above. However, the present invention is not limited to the particular exemplary embodiments, and can be modified and changed in various ways without departing from the spirit of the present invention described in claims.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-167828, filed Aug. 20, 2014, which is hereby incorporated by reference herein in its entirety.

What is claimed is:

1. A data processing apparatus in which an operation screen including a plurality of operation items can be simultaneously operated by a first operator and a second operator, the data processing apparatus comprising:
a projection unit configured to project the operation screen onto a predetermined area;
a determination unit configured to determine whether an operator who has performed an operation on the operation screen projected by the projection unit is the first operator or the second operator; and
a control unit configured to perform control so as to validate, when the determination unit determines that the operator is the first operator, an operation on a first operation item in the operation screen and an operation on a second operation item in the operation screen, and so as to validate, when the determination unit determines that the operator is the second operator, an operation on the first operation item, and to invalidate an operation on the second operation item.

2. The data processing apparatus according to claim 1, wherein the control unit is configured to perform control so as to invalidate, when the determination unit determines that the operator is the first operator, an operation on a third operation item included in the operation screen, and so as to validate, when the determination unit determines that the operator is the second operator, an operation on the third item.

3. The data processing apparatus according to claim 1, further comprising a storage unit configured to store information indicating whether each of the first operator and the second operator is authorized to perform an operation for each of the plurality of operation items included in the operation screen,
wherein the control unit is configured to perform the control based on the information stored in the storage unit.

4. The data processing apparatus according to claim 1, further comprising a range image acquisition unit configured to acquire a range image,
wherein the determination unit is configured to determine whether the operator who has performed an operation on the operation screen is the first operator or the second operator, based on the range image acquired by the range image acquisition unit.

5. The data processing apparatus according to claim 4, wherein the determination unit is configured to estimate a direction in which an operation is performed based on the range image acquired by the range image acquisition unit, and to determine whether the operator who has performed the operation on the operation screen is the first operator or the second operator based on the estimated direction and a positional relationship between the first operator and the second operator that is set in advance.

6. The data processing apparatus according to claim 4, further comprising a recognition unit configured to recognize a gesture operation performed on the operation screen based on the range image acquired by the range image acquisition unit,
wherein the determination unit is configured to determine the operator who has performed the gesture operation on the operation screen recognized by the recognition unit is the first operator or the second operator.

7. The data processing apparatus according to claim 6, wherein the recognition unit is configured to recognize the gesture operation based on a shape and a position of a hand detected from the range image acquired by the range image acquisition unit.

8. The data processing apparatus according to claim 2, further comprising a checking unit configured to check whether the first operator is at a position to be capable of operating the data processing apparatus,
wherein the control unit is configured to perform control so as to invalidate, when a result of checking by the checking unit indicates that the first operator is not at the position to be capable of operating the data processing apparatus, an operation by the second operator on the third operation item.

9. The data processing apparatus according to claim 1, further comprising an input unit configured to input an instruction of permitting the second operator to perform an operation,
wherein the control unit is configured to perform control so as to invalidate an operation by the second operator on any of the operation items in the operation screen when the instruction is not input.

10. A data processing system in which an operation screen including a plurality of operation items can be simultaneously operated by a first operator and a second operator, the data processing system comprising:
a projection unit configured to project the operation screen onto a predetermined area;
a determination unit configured to determine whether an operator who has performed an operation on the operation screen projected by the projection unit is the first operator or the second operator; and
a control unit configured to perform control so as to validate, when the determination unit determines that the operator is the first operator, an operation on a first operation item in the operation screen and an operation on a second operation item in the operation screen, and so as to validate, when the determination unit determines that the operator is the second operator, an operation on the first operation item, and to invalidate an operation on the second operation item.

11. A control method for a data processing apparatus in which an operation screen including a plurality of operation items can be simultaneously operated by a first operator and a second operator, the control method comprising:
projecting the operation screen onto a predetermined area;
determining whether an operator who has performed an operation on the projected operation screen is the first operator or the second operator; and
performing control so as to validate, when the operator is determined to be the first operator, an operation on a first operation item in the operation screen and an operation on a second operation item in the operation screen, and so as to validate, when the operator is determined to be the second operator, an operation on the first operation item, and to invalidate an operation on the second operation item.

12. A computer-readable storage medium storing a program for causing a computer to execute a control method for a data processing apparatus in which an operation screen including a plurality of operation items can be simultaneously operated by a first operator and a second operator, the control method comprising:
projecting the operation screen onto a predetermined area;
determining whether an operator who has performed an operation on the projected operation screen is the first operator or the second operator; and
performing control so as to validate, when the operator is determined to be the first operator, an operation on a first operation item in the operation screen and an operation on a second operation item in the operation screen, and so as to validate, when the operator is determined to be the second operator in the determining, an operation on the first operation item, and to invalidate an operation on the second operation item.
